(19) United States
(12) Patent Application Publication
(10) Pub. No.: US 2005/0188397 A1
(43) Pub. Date: Aug. 25, 2005

(54) Magneto-optical recording medium and magneto-optical recording medium substrate manufacturing method

(75) Inventors: Yuzuru Yamakage, Kawasaki (JP); Yasumasa Iwamura, Kawasaki (JP); Mineo Moribe, Kawasaki (JP); Takahiro Umada, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/112,276

(22) Filed: Apr. 22, 2005

Related U.S. Application Data
(63) Continuation of application No. PCT/JP03/06086, filed on May 15, 2003.

(30) Foreign Application Priority Data
Dec. 24, 2002 (JP) 2002-371783

(51) Int. Cl. G11B 5/17; G11B 7/24; G11B 23/03

(52) U.S. Cl. 720/718; 369/275.4

(57) ABSTRACT

A magneto-optical recording medium (X1) comprises a substrate (S1) and a material film structure. The substrate (S1) includes a pre-groove surface (11a) with a pre-groove (11b) formed therein, and at least the pre-groove surface (11a) is made of a soft magnetic material. The material film structure comprises a recording magnetic section (21) for executing a recording function and a reproduction function and is provided on a pre-groove surface (11a) of the substrate (S1).

### TECHNICAL FIELD

The present invention relates to a magneto-optical recording medium including a soft magnetic section and to a method for the manufacture of a substrate that can be used for the fabrication of such a magneto-optical recording medium.

### BACKGROUND ART

Magneto-optical recording media have recently attracted much attention. A magneto-optical recording medium is a rewritable recording medium constituted by using various magnetic properties of magnetic materials and having two functions: a function of thermomagnetic recording and a function of reproduction using magneto-optical effects. A magneto-optical recording medium includes a recording magnetic section composed of one or more vertically magnetized films, and a signal is recorded in the recording layer of the recording magnetic section. During recording, a prescribed magnetic filed is applied to a prescribed zone of the recording layer is by illuminating with a focused laser beam via an objective lens. The prescribed signal is thus recorded as changes in the magnetization direction in the recording layer. During reproduction, the recorded signal is read out with a prescribed optical system.

One of the known methods for increasing the recording density of magneto-optical recording media involves reducing the spot diameter, that is, the size of the medium region irradiated by the laser during recording. The decrease in the spot diameter makes it possible to design a short track pitch in the medium, reduce the recording mark length, and increase the recording density. The spot diameter can be decreased by using an illumination laser beam of a short wavelength or increasing the numerical aperture NA of the objective lens (lens facing the medium) for focusing the illumination laser beam.

The focal distance of a lens decreases with the increase in the numerical aperture NA of the lens. In the technological field of magneto-optical recording media, lenses with a large numerical aperture NA have to be employed and a strong demand is created for practical use of a front illumination system instead of a conventional back illumination system.

In the magneto-optical recording media of a back illumination system, laser illumination of the recording magnetic section during recording or reproduction is conducted from the side of a transparent substrate. Because the transparent substrate is required to have an appropriate thickness for ensuring the medium rigidity, lenses with a short focal distance, that is, lenses with a large numerical aperture, are difficult to employ with the magneto-optical recording media of a back illumination system.

By contrast, in the magneto-optical recording media of a front illumination system, the recording magnetic section is illuminated, in the recording or reproduction processing, with a laser beam from the side of the transparent protective layer provided on the side opposite that of the substrate with respect to the recording magnetic section. The transparent protective layer can therefore be made correspondingly thinner, and a lens with a shorter focal distance, that is, the lens with a large numerical aperture NA can be employed.

In the magneto-optical recording media of a front illumination system, a soft magnetic layer is sometimes provided for causing the recording layer contained in the recording magnetic section to have an increased sensitivity with respect to a magnetic field generated by a magnetic recording head (electromagnet) during recording.

FIG. 14 shows a laminated configuration of a magneto-optical recording medium X3 which is an example of the conventional magneto-optical recording media. The magneto-optical recording medium X3, composed as a magneto-optical disk of a front illumination system, has a laminated structure composed of a substrate 91, a recording magnetic section 92, a soft magnetic layer 93, a pre-groove layer 94, a heat conduction layer 95, dielectric layers 96, 97, and a protective layer 98. The above-described layers are laminated and formed form the side of substrate 91 in the order as follows: soft magnetic layer 93, pre-groove layer 94, heat conduction layer 95, dielectric layer 96, recording magnetic section 92, dielectric layer 97, and protective layer 98. Referring to FIG. 14, in the pre-groove layer 94, the surface having a pre-groove formed to the desired size is represented by a thick line.

The recording magnetic section 92, composed of one or more vertically magnetized films correspondingly to the reproduction system, has a magnetic structure capable of executing two functions: thermomagnetic recording and reproduction using a magneto-optical effect. One of the vertically magnetized films is a recording layer. The soft magnetic layer 93 is an in-plane magnetized film that is composed of a magnetic film with a high magnetic permeability and magnetized to have an axis of easy magnetization in the direction (in-plane direction) parallel to the surface of the magnetic film. The pre-groove layer 94 is a layer formed from a resin material and having a concave-convex shape for pre-groove formation on the surface of contact with the heat conduction layer 95. The heat conduction layer 95 is a zone for efficiently transferring the heat generated in the recording magnetic section 92 to the side leading to the substrate 91. The dielectric layers 96, 97 are the zones for preventing the recording magnetic section 92 from the physical and chemical influence from the outside. The protective layer 98 is a zone composed from a transparent resin material and serving for protecting the recording magnetic section 92, especially, from dust.

In the magneto-optical recording medium X3, because the soft magnetic layer 93 with a high magnetic permeability is present, the magnetic flux of the recording magnetic field applied from the magnetic recording head to the recording magnetic section 92 during recording tends to concentrate in the recording magnetic section 92, without diffusion. Thus, the sensitivity of the recording magnetic field of the recording layer contained in the recording magnetic section 92 increases over that obtained without the soft magnetic layer 93. Such a magneto-optical recording medium including a soft magnetic layer was disclosed, for example, in Japanese Patent Applications Laid-open Nos. H3-105741 and H3-137837.

The effect of magnetic field concentration in the magnetic layer caused by the presence of the soft magnetic layer increases as the recording layer and the soft magnetic layer become closer each other. However, in the conventional magneto-optical recording medium X3, the pre-groove layer 94 was present between the recording magnetic section 92 comprising the recording layer and the soft magnetic layer 93. The pre-groove layer 94 was generally made of a UV-curable resin and was required to have a thickness of at least 10 μm or more to form adequately the concave-convex shape. Because the recording magnetic section 92 comprising the recording layer and the soft magnetic layer 93 are thus at a corresponding distance from each other, the degree of magnetic field concentration is often low in the magneto-optical recording medium X3.

When a configuration employing a soft magnetic layer 93 between the recording magnetic section 92 and pre-groove layer 94 is used instead of the configuration in which the pre-groove layer 94 is provided between the recording magnetic section 92 and soft magnetic layer 93, the distance between the recording magnetic section 92 and soft magnetic layer 93 becomes shorter. However, in this case, the adequate land-groove shape cannot be formed in the recording magnetic section 92. As a result, a magneto-optical recording medium suitable for practical use cannot be obtained.

In order to obtain the magnetic field concentration effect, the soft magnetic layer 93 is required to have a thickness of at least 100 nm or more, and if a film of a soft magnetic material is formed on the pre-groove layer 94 to a thickness of about 100 nm or more by a sputtering method, the concave-convex shape formed in the soft magnetic layer 93 changes to the respective degree with respect to the concave-convex shape of the pre-groove layer 94 itself and becomes rounded. For this reason, the land and groove shape formed in the recording magnetic section 92, which is further laminated and formed on top of the soft magnetic layer 93, becomes greatly deviated from the concave-convex shape of the pre-groove layer 94. In addition, in the case of growing a film of the soft magnetic material on the pre-groove layer 94 to a thickness of about 100 nm or more by a sputtering method, the surface roughness on the upper end side of the soft magnetic layer 93 correspondingly increases. As a result, the surface roughness on the upper end side of the recording magnetic section 92 that is further laminated and formed on top of the soft magnetic layer 93 becomes inappropriately larger.

Thus, when a configuration is used in which the soft magnetic layer 93 is provided between the recording magnetic section 92 and the pre-groove layer 94, an adequate land and groove shape cannot be formed in the recording magnetic section 92. When an adequate land and groove shape cannot be formed in the recording magnetic section 92, a good recording and reproduction characteristic cannot be obtained. For example, a sufficiently high CNR cannot be obtained.

### DISCLOSURE OF THE INVENTION

The present invention has been proposed under the circumstances described above. It is therefore an object of the present invention to provide a magneto-optical recording medium in which the recording layer contained in the recording magnetic section can be brought adequately close to the soft magnetic section provided for increasing the recording magnetic field sensitivity of the recording layer and also to provide a method for making a substrate that can be used for the fabrication of such a magneto-optical recording medium.

In accordance with the first aspect of the present invention, there is provided a magneto-optical recording medium. This magneto-optical recording medium comprises a substrate and a material film structure. The substrate includes a pre-groove surface having a pre-groove formed therein, and at least the pre-groove surface is made of a soft magnetic material. The material film structure comprises a recording magnetic section for executing a recording function and a reproduction function and is provided on the pre-groove surface of the substrate. The pre-groove in accordance with the present invention is a shape formed by transferring a land and groove shape (concave-convex shape) designed in the stamper, and this shape directly reflects the land and groove shape of the stamper. Therefore, the pre-groove in accordance with the present invention does not contain the concave-convex shape produced by forming a film of a material on the surface with a shape formed by transferring the land and groove shape of the stamper. Furthermore, the material film structure in accordance with the present invention is a zone having a multilayer structure and laminated and formed on the substrate.

In the magneto-optical recording medium having such a configuration, the recording layer contained in the recording magnetic section and the soft magnetic section for increasing the recording magnetic field sensitivity of the recording layer can be provided adequately close to each other. With the first aspect of the present invention, the pre-groove surface in the substrate where the pre-groove has been formed is made of a soft magnetic material. Thus, the substrate, in at least part of the surface thereof, includes a soft magnetic section regulating the pre-groove surface. The recording magnetic field sensitivity of the recording layer provided on the pre-groove surface can be increased to the desired level by adjusting the amount or thickness of the soft magnetic section. The material film structure comprising the recording magnetic section is directly laminated and formed, without a soft magnetic layer, on the pre-groove surface having the pre-groove shape formed to the desired dimensions. Therefore, the recording magnetic section can have the adequate land and groove shape. Furthermore, the material film structure comprising the recording magnetic section is directly laminated and formed on the soft magnetic section, rather than via the pre-groove layer. Therefore, the recording layer contained in the recording magnetic section and the soft magnetic section can be sufficiently close to each other.

Thus, with the magneto-optical recording medium according to the first aspect of the present invention, an adequate land and groove shape can be realized in the recording and magnetic section and a sufficiently short distance can be obtained between the recording layer contained in the recording magnetic section and the soft magnetic layer.

In the preferred embodiment of the first aspect of the present invention, the substrate is made of a soft magnetic material. In this case, the soft magnetic material preferably has a saturation magnetic field density of 0.5 T or more. In the present configuration, the entire substrate is equivalent to the soft magnetic layer. When the entire substrate having a thickness sufficient to ensure the rigidity of the medium is made of a soft magnetic material, a saturation magnetic field density of the soft magnetic material of 0.5 or more is advantageous in terms of obtaining the sufficient effect in magnetic field concentration with the soft magnetic substrate.

In another preferred embodiment, the substrate includes a soft magnetic film constituting the pre-groove surface. In this case, the product of the saturation magnetic field density of the soft magnetic material constituting the soft magnetic film and the thickness of the soft magnetic film is preferably 2×10⁻⁷ Tm or more. The Bs×t product of 2×10⁻⁷ Tm or more is advantageous in terms of obtaining a sufficient effect in magnetization concentration with the soft magnetic film, where Bs(T) stands for a saturation magnetic field density of the soft magnetic material constituting the soft magnetic film and t(m) stands for a thickness of the soft magnetic film.

In the first aspect of the present invention, the pre-groove surface preferably has a surface roughness (Ra) of 0.3 nm or less.

In the technological field of magneto-optical recording media, a variety of reproduction systems have been developed to reproduce with good utility the signals that were recorded with a high density surpassing the resolution limit in the optical system for reading the reproduced signals. Examples of such systems include a MSR (magnetically induced super resolution), MAMMOS (magnetic amplifying magneto-optical system) and DWDD (domain wall displacement detection). In accordance with the first aspect of the present invention, the material film structure preferably has a multilayer magnetic structure for realizing the reproduction in such MSR system, MAMMOS system, or DWDD system. The effect of the present invention is especially high when the present invention is implemented in the magneto-optical recording medium of the MSR system, MAMMOS system, and DWDD system that have excellent reproduction resolution.

In accordance with the second aspect of the present invention, there is provided a method for manufacturing a magneto-optical recording medium substrate. This method comprises the steps of forming a substrate made of a soft magnetic material and including a pre-groove surface with the concave-convex shape of a pre-groove formation surface transferred thereto by growing a soft magnetic material by an electroforming method on the pre-groove formation surface in a stamper having the pre-groove formation surface, and separating the substrate and the stamper.

With this method, the substrate according to the first aspect of the present invention can be adequately manufactured. In the second aspect of the present invention, the soft magnetic material preferably has a saturation magnetic flux density of 0.5 T or higher.

In accordance with the third aspect of the present invention, there is provided another method for manufacturing a magneto-optical recording medium substrate. This method comprises the steps of forming a resist pattern on the surface of a soft magnetic plate, forming a pre-groove by conducting an etching processing of the soft magnetic plate with the resist pattern as a mask, and removing the resist pattern from the soft magnetic plate.

With this method, the substrate according to the first aspect of the present invention can be adequately manufactured. In the third aspect of the present invention, the etching processing is preferably conducted by an ion milling method. Further, the soft magnetic plate is preferably made of a soft magnetic material with a saturation magnetic flux density of 0.5 T or higher. The soft magnetic plate preferably has a surface roughness (Ra) of 0.3 nm or less.

In accordance with the fourth aspect of the present invention, there is provided another method for manufacturing a magneto-optical recording medium substrate. This method comprises the steps of forming a soft magnetic film having a concave-convex shape of a pre-groove formation surface transferred thereto by growing a soft magnetic material on the pre-groove formation surface in a stamper including the pre-groove formation surface, forming a substrate having a laminated structure composed of a resin layer and the soft magnetic film by forming the resin layer on the soft magnetic film, and separating the substrate and the stamper.

With this method, the substrate according to the first aspect of the present invention can be adequately manufactured. In the fourth aspect of the present invention, the product of the saturation magnetic flux density of the soft magnetic material constituting the soft magnetic film and the thickness of the soft magnetic film is preferably 2×10⁻⁷ Tm or higher.

The soft magnetic film is preferably formed by an electroless plating method and the resin layer is made of polycarbonate (PC) or polymethylmethacrylate (PMMA).

The adhesion between the electroless plated film made of the soft magnetic material and the PC or PMMA is comparatively low. Therefore, this configuration is advantageous for effectively implementing the operation of separating the substrate and stamper.

### BRIEF DESCRIPTION OF THE DRAWINGS

FIG. 1 is a partial cross-sectional view of the magneto-optical recording medium of the first embodiment of the present invention;

FIGS. 2A-2C illustrate some steps of the method for the manufacture of the magneto-optical recording medium shown in FIG. 1;

FIGS. 3A-3C show the steps following the step illustrated by FIG. 2C;

FIG. 4A and FIG. 4B show the steps following the step illustrated by FIG. 3C;

FIG. 5 is a partial cross-sectional view of the magneto-optical recording medium of the second embodiment of the present invention;

FIGS. 6A-6C illustrate some steps of the method for the manufacture of the magneto-optical recording medium shown in FIG. 5;

FIG. 7A and FIG. 7B show the steps following the step illustrated by FIG. 6C;

FIG. 8A and FIG. 8B show the steps following the step illustrated by FIG. 7B;

FIG. 9 shows a laminated configuration in the information track of the magneto-optical recording medium of Embodiment 1;

FIG. 10 shows a laminated configuration in the information track of the magneto-optical recording medium of Embodiment 2;

FIG. 11 shows a laminated configuration in the information track of the magneto-optical recording medium of Comparative Example 1;

FIG. 12 shows a laminated configuration in the information track of the magneto-optical recording medium of Comparative Example 2;

FIG. 13 is a graph illustrating the dependence of the bit error rate on the recording magnetic field for the magneto-optical recording medium of Embodiments 1, 2 and Comparative Examples 1, 2; and

FIG. 14 shows a laminated configuration in the information track of the magneto-optical recording medium.

### BEST MODE FOR CARRYING OUT THE INVENTION

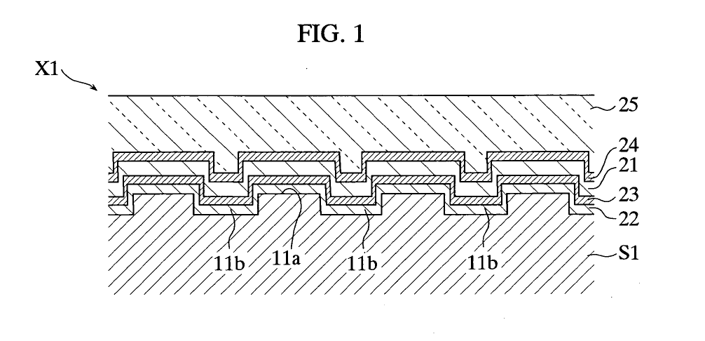

FIG. 1 shows a magneto-optical recording medium X1 of a first embodiment of the present invention. The magneto-optical recording medium X1 comprises a substrate S1, a recording magnetic section 21, a heat conduction layer 22, dielectric layers 23-24 and a protective layer 25, so that the recording medium is used as a magneto-optical disk of a front illumination system. In the magneto-optical recording medium X1 of the present invention, the structure shown in FIG. 1 is provided only on one side or on both sides of the substrate S1. In the present invention, the recording magnetic section 21, the heat conduction layer 22, the dielectric layers 23-24 and the protective layer 25 together constitute a ‘material film structure.’

The substrate S1 is made of a soft magnetic material and includes a pre-groove surface 11a formed with pre-grooves 11b of required dimensions. Examples of soft magnetic materials constituting the substrate S1 include Fe-based amorphous materials such as FeC, Co-based amorphous material, permalloy, and sendust.

The recording magnetic section 21 has a magnetic structure including one or more magnetic films capable of realizing two functions: a thermomagnetic recording function and a reproduction function using a magneto-optical effect. This recording magnetic section constitutes an information track in the magneto-optical recording medium X1. For example, the recording magnetic section 21 includes a single recording layer having both the recording function and the reproduction function. Alternatively, the recording magnetic section 21 has a two-layer structure composed of a recording layer having a relatively large coercive force and serving to realize the recording function and a reproduction layer having a comparatively large Kerr rotation angle in the reproduction laser beam and serving to realize the reproduction function. Alternatively, the recording magnetic section 21 has at least a three-layer structure comprising a recording layer, a reproduction layer, and an intermediate layer located between them for realizing reproduction in a MSR system, a MAMMOS system, or a DWDD system.

Each layer in every possible structure of the recording magnetic section 21 is a vertically magnetized film made of an amorphous alloy of rare earth elements and transition metals, having a vertical magnetic anisotropy, and magnetized in the vertical direction. The vertical direction is the direction vertical with respect to the surface of the magnetic film constituting each layer. Tb, Gd, Dy, Nd or Pr can be used as the rare earth element. Fe or Co can be used as the transition element.

More specifically, the recording layer is composed, for example, of TbFeCo, DyFeCo, or TbDyFeCo having the prescribed composition. When a reproduction layer is provided, this reproduction layer is composed, for example, of GdFeCo, GdDyFeCo, GdTbDyFeCo, NdDyFeCo, NdGdFeCo, or PrDyFeCo having the prescribed composition. When an intermediate layer is provided, this intermediate layer is composed, for example, of GdFe, TbFe, GdFeCo, GdDyFeCo, GdTbDyFeCo, NdDyFeCo, NdGdFeCo, or PrDyFeCo having the prescribed composition. The thickness of each layer is determined according to the magnetic structure desired for the recording magnetic section 21.

The heat conduction layer 22 is a zone for efficiency transferring the heat generated in the recording magnetic section 21 or the like during laser illumination to the substrate S1 and is made of a material with a high thermal conductivity, for example, Ag, Ag alloys (AgPdCuSi, AgPdCu and the like), Al alloys (AlTi, AlCr, and the like), Au or Pt. The thickness of the heat conduction layer 22 is for example 10-50 nm.

The dielectric layers 23, 24 are the zones for avoiding or inhibiting the magnetic influence on the recording magnetic section 21 from the outside and are composed, for example, of SiN, SiO₂, YSiO₂, ZnSiO₂, AlO, or AlN. The thickness of the dielectric layer 23 is for example 10-30 nm. The thickness of the dielectric layer 24 is for example 35-50 nm.

The protective film 25 is formed from a resin having sufficient transparency to the laser beam for recording on the magneto-optical recording medium X1 and the laser beam for reproduction. The thickness of the protective film is for example 10-40 μm. Examples of resins for constituting the protective film 25 include polycarbonate (PC) resins, polymethylmethacrylate (PMMA) resins, epoxy resins, or polyolefin resins.

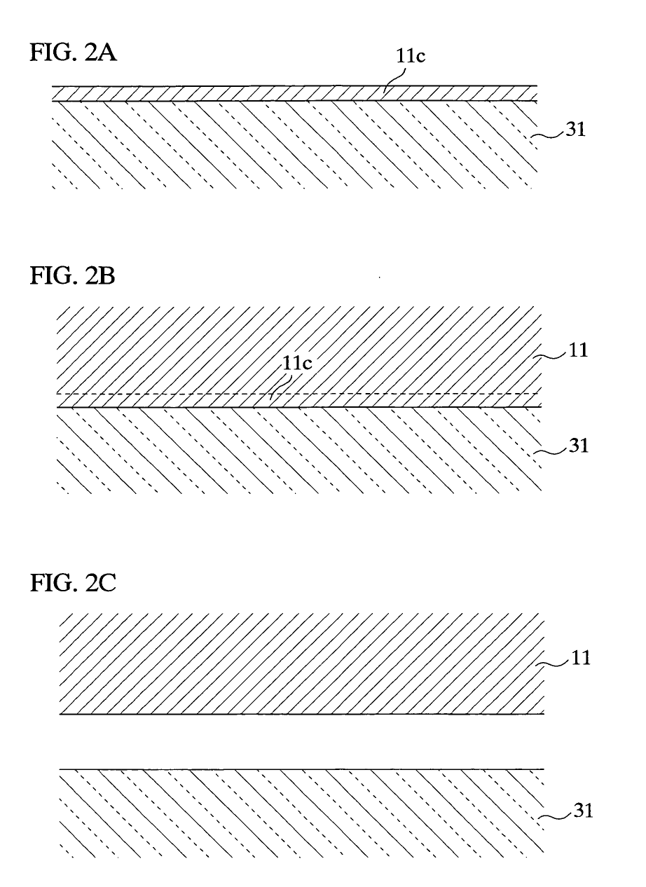

A method for the manufacture of the magneto-optical recording medium X1 is illustrated by FIGS. 2A to 4B. In the manufacture of the magneto-optical recording medium X1, first, as shown in FIG. 2A, a soft magnetic film 11c is formed on a glass substrate 31. The surface of the glass substrate 31 is subjected in advance to the prescribed smoothing treatment. The soft magnetic film 11c can be formed by growing a film of the above-mentioned soft magnetic material for constituting the substrate S1, for example, by a sputtering method. The thickness of the soft magnetic film 11c is for example 10-1000 nm.

Then, as shown in FIG. 2B, a soft magnetic plate 11 is formed by an electroforming method. More specifically, the soft magnetic film 11c is used as an electrically conductive layer based on the principle of electroplating and the same soft magnetic material is plated and grown on the soft magnetic film 11c. The soft magnetic plate 11 having a sufficient thickness is thus formed. Then, as shown in FIG. 2C, the glass substrate 31 is peeled off from the soft magnetic plate 11.

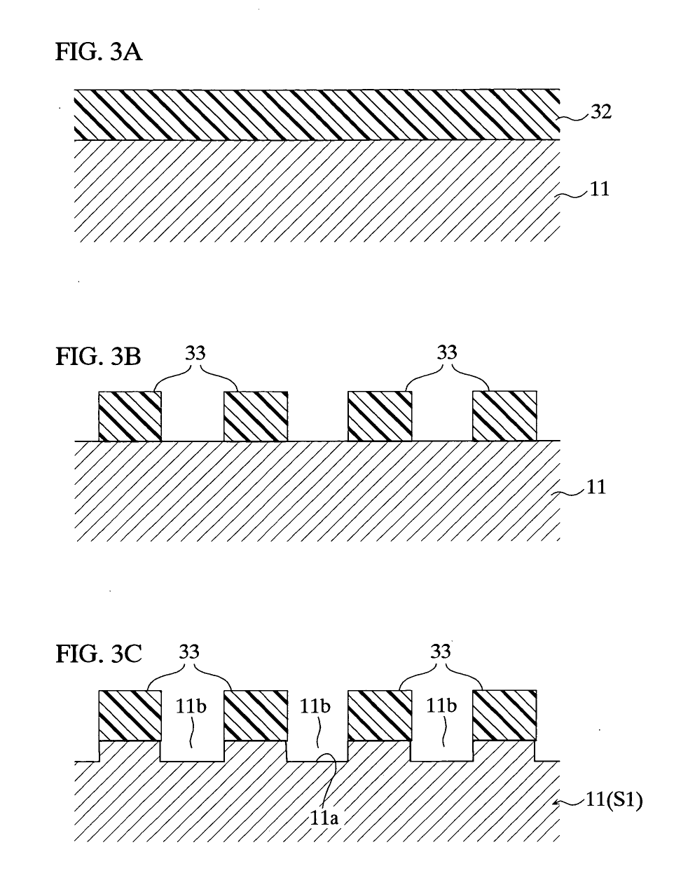

The soft magnetic plate 11 is then press processed to obtain a disk of the prescribed outer diameter, and then a resist film 32 is formed, as shown in FIG. 3A, by growing a film of a liquid photoresist on the soft magnetic plate 11. A spin coating method can be used as a film growing method.

Then, as shown in FIG. 3B, a resist pattern 33 is formed by exposing the resist film 32 and then conducting a development treatment. The resist pattern 33 has a pattern shape corresponding to the pre-groove 11b that is to be formed.

Then, as shown in FIG. 3C, the prescribed groove, that is, pre-groove 11b is formed in the soft magnetic plate 11 by an ion milling method using the resist pattern 33 as a mask. The resist pattern 33 is thereafter removed from the soft magnetic plate 11. The substrate S1 including the pre-groove surface 11a is thus manufactured.

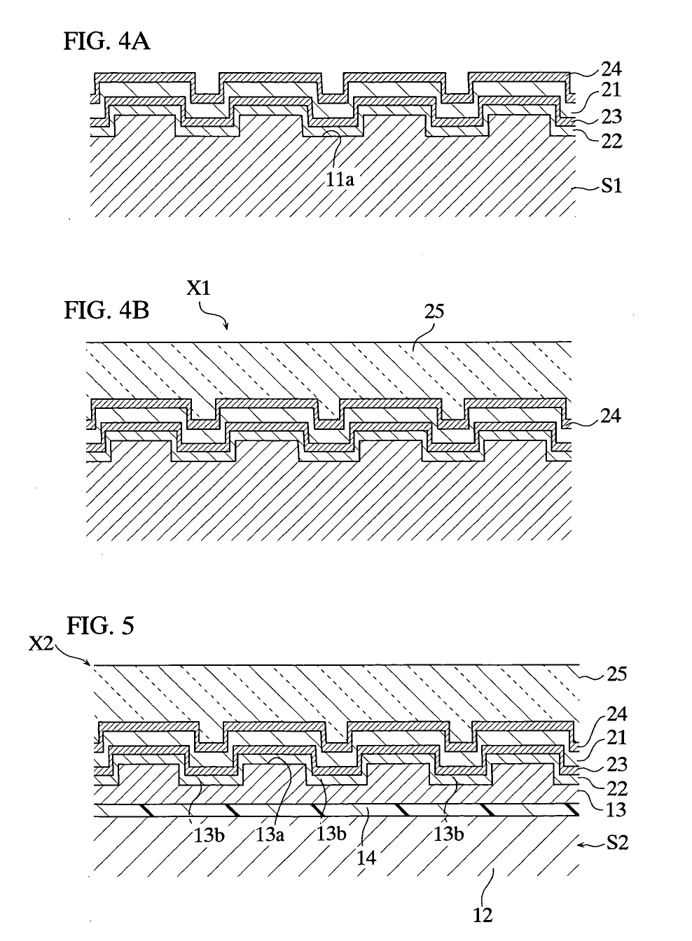

In the manufacture of the magneto-optical recording medium X1, then, as shown in FIG. 4A, a heat conduction layer 22, a dielectric layer 23, a recording magnetic section 21, and a dielectric layer 24 are successively formed on the pre-groove surface 11a of the substrate S1. Each layer can be formed by a sputtering method.

Then, as shown in FIG. 4B, a protective film 25 is formed on the dielectric layer 24. In the formation of the protective film 25, a film of a liquid resin composition is grown on the dielectric layer 24. A spin coating method can be employed as the film growing method. Resin compositions comprising as the main component the resin described above as a constituent material of the protective film 25 and having UV curability, thermal curability, or catalytic curability are used as the resin composition. The grown film of the resin composition is then cured. A method for UV irradiating the resin composition, or heating the resin, or treating the resin with a catalyst can be employed according to the curing characteristics of the resin composition as the curing method. When a catalyst is used, the catalyst is added in advance to the resin composition during film growing. The protective layer 25 can thus be formed.

When the structure shown in FIG. 1 is provided on both surfaces of the substrate S1, the series of the operations described hereinabove with reference to FIGS. 3A to 4B are also conducted with respect to other surface of the substrate S1. The magneto-optical recording medium X1 can be manufactured in the above-described manner.

In the magneto-optical recording medium X1, the substrate S1 is made of a soft magnetic material and includes a pre-groove surface 11a. Thus, the substrate S1 is by itself a soft magnetic layer and a pre-groove layer.

In the process described above with reference to FIG. 4A, the heat conduction layer 22, dielectric layer 23, and recording magnetic section 21 are laminated and formed, without a soft magnetic layer, on the pre-groove surface 11a having the pre-groove 11b formed to the described size. Therefore, the recording magnetic section 21 can be adequately formed so as to have a land and groove shape of high dimensional accuracy. Thus, the recording magnetic section 21 can be formed without having an inappropriately large surface roughness and without inappropriate rounding.

In addition, because the heat conduction layer 22, dielectric layer 23, and recording magnetic section 21 are directly laminated and formed on the soft magnetic section (substrate S1), without a pre-groove layer, the soft magnetic section (substrate S1) and the recording layer contained in the recording magnetic section 21 can be brought sufficiently close to each other.

Thus, in the magneto-optical recording medium X1, an adequate land and groove shape can be realized in the recording magnetic section 21 and the distance between the soft magnetic section (substrate S1) and the recording layer contained in the recording magnetic section 21 can be made sufficiently small.

In the magneto-optical recording medium X1 in which the distance between the soft magnetic section (substrate S1) and the recording layer contained in the recording magnetic section 21 is small, the magnetic field concentration effect caused by the presence of the soft magnetic section can be fully received. Therefore, the recording magnetic field sensitivity of the recording layer can be efficiently increased. The increase in the recording magnetic field sensitivity of the recording layer makes it possible to reduce the applied magnetic field created by the magnetic recording head during recording. As a result, the recording at a higher frequency or the high-speed recording can be adequately realized. Such a transition to high-speed recording is important for realizing a magneto-optical recording medium with a high recording density.

FIG. 5 shows a magneto-optical recording medium X2 of the second embodiment of the present invention. The magneto-optical recording medium X2 comprises a substrate S2, a recording magnetic section 21, a heat conduction layer 22, dielectric layers 23, 24, and a protective layer 25 and is composed as a magneto-optical disk of a front illumination system. In accordance with the present invention, in the magneto-optical recording medium X2, the structure shown in FIG. 5 is present only on one side or on both sides of the substrate S2.

The substrate S2 includes a base material 12 and a soft magnetic film 13. The soft magnetic section 13 includes a pre-groove surface 13a having a pre-groove 13b of the desired dimensions formed therein. The base material 12 is, for example, a flat glass substrate or resin substrate. Examples of soft magnetic materials constituting the soft magnetic film 13 include Fe-based amorphous materials such as FeC, Co-based amorphous material, permalloy, and sendust. In the present embodiment, the soft magnetic film 13 has a saturated magnetic flux density and thickness satisfying the formula (1) hereinbelow, wherein the saturation magnetic flux density of the soft magnetic material constituting the soft magnetic film 13 is denoted by Bs(T) and the thickness of the soft magnetic film 13 is denoted by t (m). The soft magnetic film 13 can receive the effect of magnetic field concentration in the recording layer contained in the recording magnetic section 21 if the saturated magnetic flux density is increased to satisfy the formula (1) when the film is thin, or if the film thickness is increased to satisfy the formula (1) when the saturated magnetic flux density is small.

The configurations of the recording magnetic section 21, heat conduction layer 22, dielectric layers 23, 24, and protective layer 25 of the magneto-optical recording medium X2 are identical to those described with reference to the magneto-optical recording medium X1.
Bs×t=2×10⁻⁷ (Tm) (1)

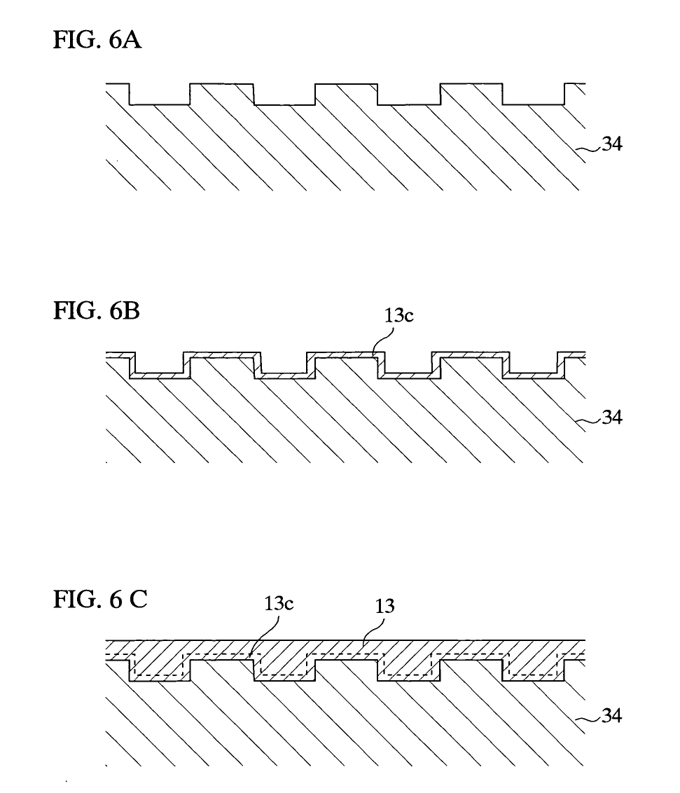

FIGS. 6A to 8B illustrate a method for the manufacture of the magneto-optical recording medium X2. In the manufacture of the magneto-optical recording medium X2, first, a stamper 34 shown in FIG. 6A is prepared. The stamper 34 is composed, for example, of a resin such as a polycarbonate and has the prescribed concave-convex shape corresponding to the pre-groove 13b that will be formed in the substrate S2.

Then, as shown in FIG. 6B, a soft magnetic thin film 13c is formed on the concave-convex surface of the stamper 34. The soft magnetic thin film 13c can be formed by growing a film of the above-mentioned soft magnetic material, for example, by sputtering. The thickness of the soft magnetic thin film 13c is, for example, 10-50 nm. Then, as shown in FIG. 6C, the identical soft magnetic material is grown on the soft magnetic thin film 13c by an electroless plating method. The soft magnetic film 13 is thus formed.

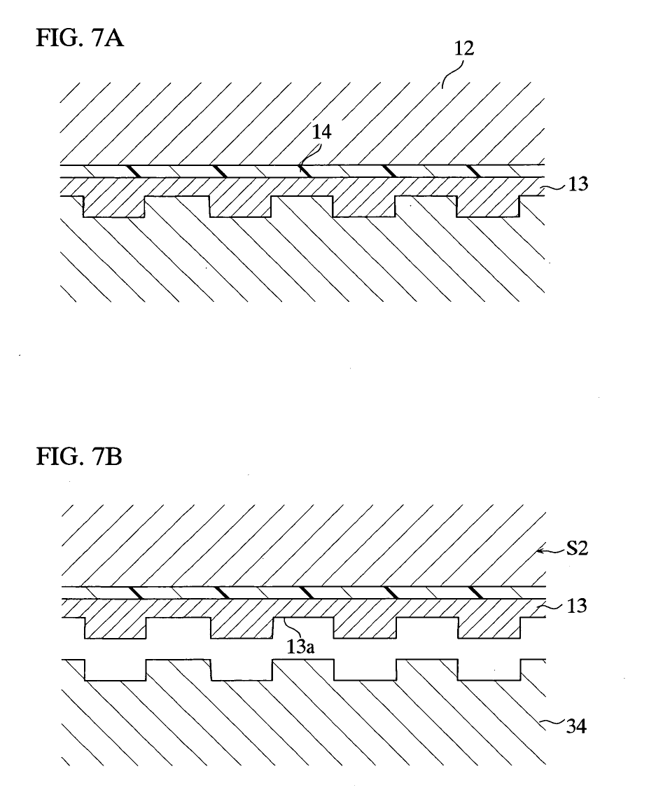

Then, as shown in FIG. 7A, a base material 12 is bonded via an adhesive 14 to the soft magnetic film 13. A UV-curable resin can be used as the adhesive 14. Then, as shown in FIG. 7B, the stamper 34 is peeled off from the soft magnetic film 13. A substrate S2 including the pre-groove surface 13a is thus manufactured.

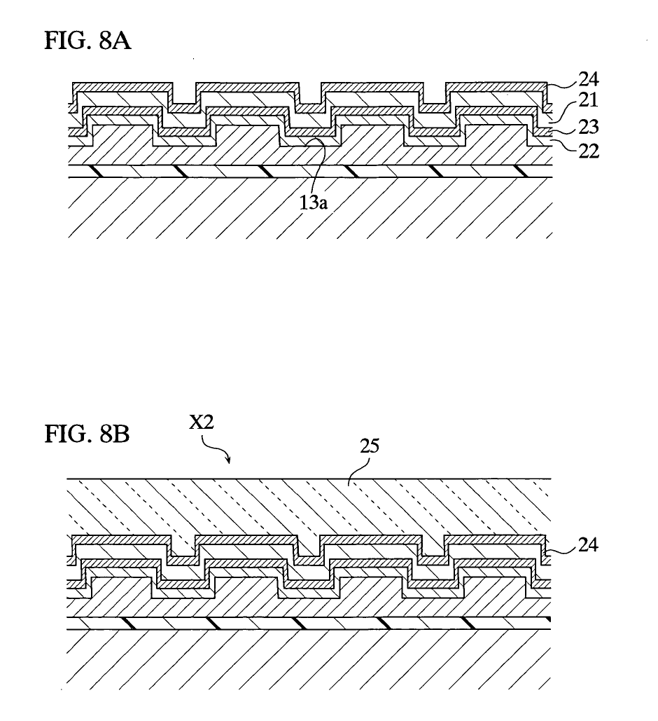

In the manufacture of the magneto-optical recording medium X2, the heat conduction layer 22, dielectric layer 23, recording magnetic section 21, and dielectric layer 24 are then successively formed on the pre-groove surface 13a of the substrate S2, as shown in FIG. 8A. Each layer can be formed by sputtering. Then, as shown in FIG. 8B, the protective layer 25 is formed on the dielectric layer 24. The technique for forming the protective layer 25 is identical to that described hereinabove with reference to FIG. 4B.

When the structure shown in FIG. 5 is provided on both sides of the substrate S2, the series of steps described hereinabove with reference to FIGS. 6A to 8B are conducted on the other side of the substrate S2. The magneto-optical recording medium X2 can thus be manufactured.

In the magneto-optical recording medium X2, the substrate S2 includes the pre-groove surface 13a, and this pre-groove surface 13a is regulated by the soft magnetic film 13.

In the step described hereinabove with reference to FIG. 8A, the heat conduction layer 22, dielectric layer 23, and recording magnetic section 21 are laminated and formed, without a soft magnetic layer, on the pre-groove surface 13a having the pre-groove 13b formed to have the desired dimensions. Therefore, the recording magnetic section 21 can be adequately formed so as to have a land and groove shape of high dimensional accuracy. Thus, the recording magnetic section 21 can be formed without inappropriate rounding and does not have inappropriately large surface roughness.

Moreover, the heat conduction layer 22, dielectric layer 23, and recording magnetic section 21 are directly laminated and formed on the soft magnetic film 13, without a pre-groove layer. Therefore, the soft magnetic film 13 and the recording layer contained in the recording magnetic section 21 can be brought sufficiently close to each other. The soft magnetic film 13 constituted to satisfy the above-described formula (1) can effectively function as a soft magnetic section.

Here, in the magneto-optical recording medium X2, an adequate land and groove shape can be realized in the recording magnetic section 21 and the distance between the soft magnetic film 13 and the recording layer contained in the recording magnetic section 21 can be sufficiently shortened.

In the magneto-optical recording medium X2 with a short distance between the soft magnetic section and the recording layer contained in the recording magnetic section 21, the magnetic field concentration effect caused by the presence of the soft magnetic section can be sufficiently demonstrated and the recording magnetic field sensitivity of the recording layer can be efficiency increased.

### Embodiment 1

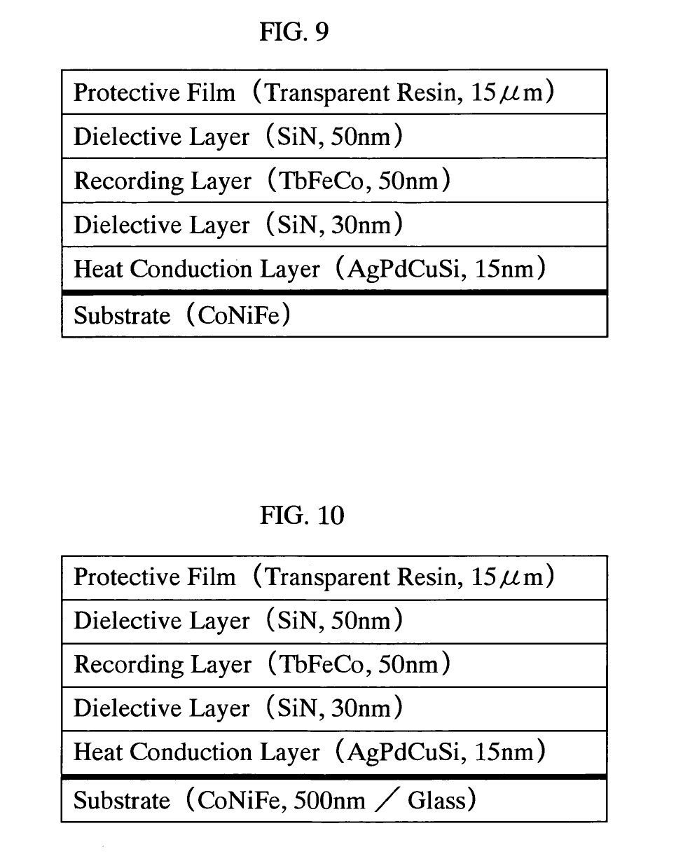

A magneto-optical recording medium of the present embodiment was fabricated as a magneto-optical disk of a front illumination system having a multilayer configuration shown in FIG. 9.

In the fabrication of the magneto-optical recording medium of the present embodiment, first, CoNiFe, which is a soft magnetic material, is deposited by a sputtering method on a glass substrate (diameter 200 mm, surface roughness Ra 0.25 nm) to form a soft magnetic film with a thickness of 50 nm.

Then, a soft magnetic plate with a thickness of 0.3 mm is formed on the glass substrate by an electroforming method. More specifically, CoNiFe of the prescribed composition and having a saturated magnetic flux density of 1.0 T is grown on the soft magnetic film by an electroplating method using a soft magnetic film formed in the above-described manner as an electrically conductive layer.

The soft magnetic layer is then peeled off from the glass substrate. The soft magnetic plate is thereafter subjected to pressing by using a press machine to obtain an outer diameter of 120 mm. A soft magnetic disk (diameter 120 mm, thickness 0.3 mm, surface roughness Ra 0.25 nm) made of a CoNiFe alloy, which is a soft magnetic material, is thus fabricated.

In the fabrication of the magneto-optical recording medium of the present embodiment, a photoresist (trade name; DVR-300, manufactured by Zeon Corporation) was coated to a thickness of 200 nm by a spin coating method on the surface of the soft magnetic plate with a surface roughness of Ra 0.25 nm. The photoresist film was then pre-baked for 30 minutes at a temperature of 100° C. The photoresist film was thereafter exposed with the prescribed pre-groove pattern (spiral shape, groove width 0.3 μm, track pitch 0.3 μm) by using an optical disk exposure apparatus (exposure laser: Ar laser with a wavelength of 351 nm, objective lens: numerical aperture NA 0.90). A resist pattern was then formed by developing the exposed photoresist. NMD-W (manufactured by Tokyo Ohka Kogyo Co., Ltd.) was used as the development solution. After the development, the photoresist was post-baked for 30 minutes at a temperature of 140° C.

The soft magnetic plate was etched by an ion milling method conducted by using an ion milling apparatus (manufactured by Ulvac Inc.) with the resist pattern formed on the soft magnetic layer in the above-described manner as the mask, and a pre-groove with a depth of 50 nm having the prescribed pattern was formed on the soft magnetic plate. In this etching treatment, Ar gas was used as the etching gas, the gas pressure was 0.5 Pa, the RF input power was 0.8 kW, and the etching time was 10 minutes.

The resist pattern was then removed from the soft magnetic plate having the pre-groove formed therein. The magneto-optical recording medium of the present embodiment was thus fabricated. This substrate has a pre-groove pattern (spiral, groove width 0.3 μm, track pitch 0.3 μm) with a depth of 50 nm on the pre-groove surface (shown by thick lines in FIG. 9).

In the fabrication of the present magneto-optical recording medium, a heat conduction layer with a thickness of 15 nm was then formed by growing a film of a Ag alloy (AgPdCuSi) by a DC sputtering method conducted by employing a DC magnetron sputtering apparatus (manufactured by Alvac Co., Ltd.) on the substrate surface where the pre-groove pattern has been formed. More specifically, co-sputtering using a AgPdCu alloy target and Si target was conducted, an Ar gas was used as a sputter gas, the sputter gas pressure was set to 1.5 Pa, and the discharge power was set to 800 W.

Then, a first dielectric layer with a thickness of 30 nm was formed by growing a film of SiN on the heat conduction layer by a DC sputtering method. More specifically, a SiN was grown on the substrate by reactive sputtering conducted by using a Si target and employing Ar gas and N₂ gas as sputter gases. In this sputtering, the flow rate ratio of Ar gas and N₂ gas was set to 3:1, the sputter gas pressure was set to 1.5 Pa, and the discharge power was set to 800 W.

A recording layer with a thickness of 50 nm was then formed by growing a film of a TbFeCo amorphous alloy of the prescribed composition on the first dielectric layer by the DC sputtering method. In the present sputtering process, a TbFeCo alloy target was used, Ar gas was employed as the sputter gas, the sputter gas pressure was set to 1.5 Pa, and the discharge power was set to 500 W.

A second dielectric layer with a thickness of 50 nm was then formed by growing a SiN film on the recording layer by the DC sputtering method. The SiN film forming conditions were identical to those described above with respect to the formation of the first dielectric layer.

The UV-curable resin (trade name: Daicure Clear, manufactured by Mitsubishi Chemical Co., Ltd.) was then grown on the second dielectric layer to a film thickness of 15 μm by a spin coating method. This UV-curable resin film was then cured by UV irradiation (wavelength close to 365 nm) and a transparent protective film (thickness 15 μm) was formed on the second dielectric layer.

The magneto-optical recording medium of the present embodiment was thus fabricated.

### Embodiment 2

A magneto-optical recording medium of the present embodiment was fabricated as a magneto-optical disk of a front illumination system having a multilayer configuration shown in FIG. 10.

In the fabrication of the magneto-optical recording medium of the present embodiment, first, a resin stamper with the prescribed land and groove shape is prepared. This resin stamper is made from a polycarbonate and is molded by a resin injection molding method conducted by disposing in a mold a Ni stamper fabricated by the conventional optical disk base fabrication process. The land and groove shape of the resin stamper is such as to form in the subsequent process a pre-groove pattern identical to the pre-groove pattern with a depth of 50 nm that is formed on the magneto-optical recording medium substrate of Embodiment 1.

A soft magnetic thin film with a thickness of 50 nm was then formed by growing a CoNiFe film, which is a soft magnetic material, by a sputtering method on the resin stamper.

A soft magnetic film with a thickness of 500 nm was formed by growing a film of CoNiFe of the prescribed composition having a saturated magnetic flux density of 1.0 T by an electroless plating method on the soft magnetic thin film. The soft magnetic film of the present embodiment has a configuration satisfying the above-described formula (1). The plated film of the soft magnetic material formed on the resin stamper has a sufficient adhesion to the resin plate in the process of growing the plated film, but does not have adhesion high enough to hinder the below-described peeling operation.

A flat glass substrate (diameter 120 mm, thickness 1.2 mm) was then applied via a UV-curable resin (trade name: Yupimer, manufactured by Mitsubishi Chemical Co., Ltd.) to the soft magnetic film located on the resin stamper, and the UV-curable resin was cured by UV irradiation (wavelength 255 nm).

The soft magnetic film that was thus integrated with the glass substrate via the UV-curable resin was peeled off from the resin stamper. The magneto-optical recording medium substrate of the present embodiment that was made of the soft magnetic film (saturated magnetic flux density 1.0 T, thickness 500 nm) and glass substrate (diameter 120 nm, thickness 1.2 mm) was thus fabricated. This substrate has a pre-groove pattern with a thickness of 50 nm regulated by the soft magnetic film on the pre-groove surface (shown by a thick line in FIG. 10). This pre-groove pattern is the same as the pre-groove pattern in Embodiment 1.

In the fabrication of the magneto-optical recording medium of the present embodiment, a heat conduction layer (AgPdCuSi, thickness 15 nm), first dielectric layer (SiN, thickness 30 nm), recording layer (TbFeCo, thickness 50 nm), second dielectric layer (SiN, thickness 50 nm), and protective layer (UV-curable transparent resin, thickness 15 μm) were successively formed on the soft magnetic film of the substrate. Methods for forming those layers are identical to those described in Embodiment 1.

The magneto-optical recording medium of the present embodiment was thus fabricated.

### COMPARATIVE EXAMPLE 1

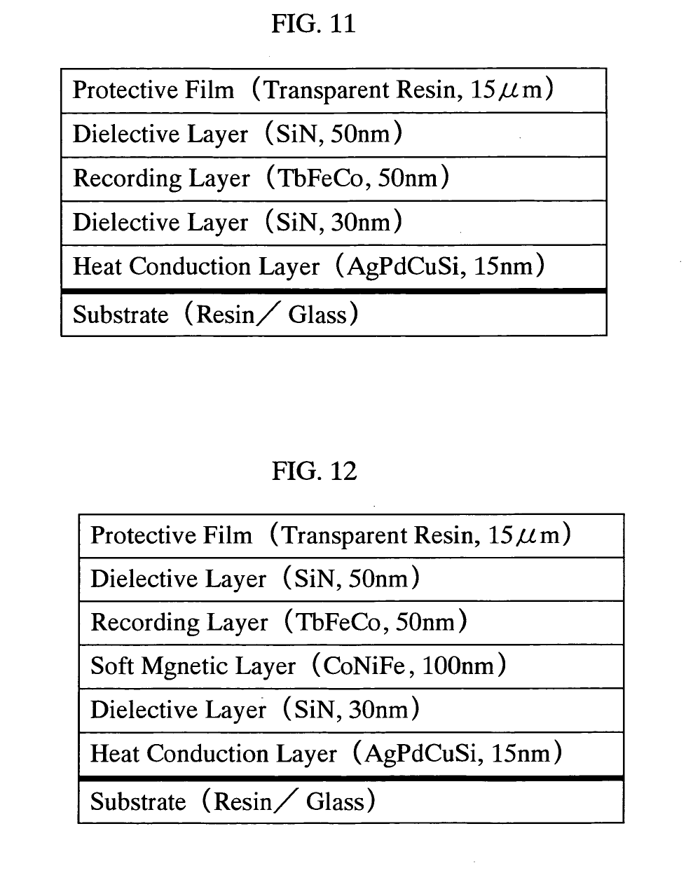

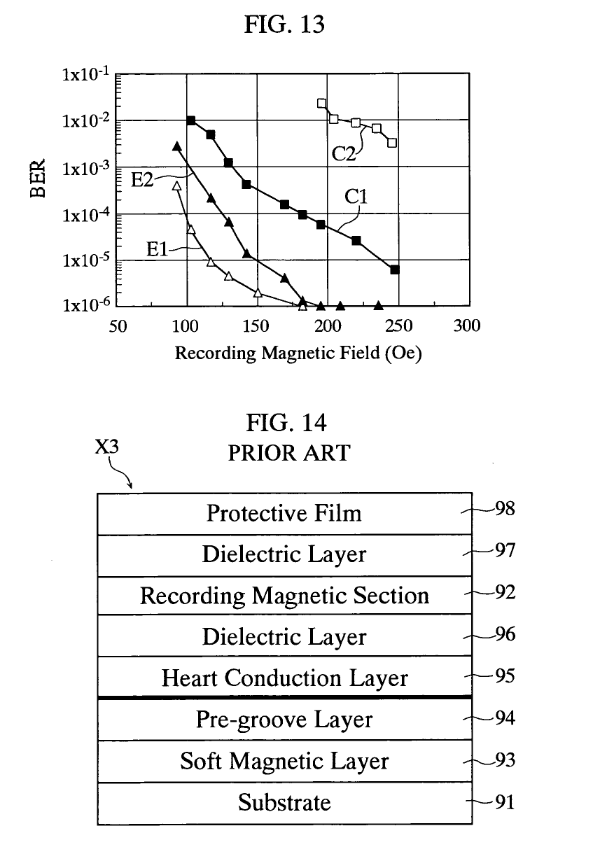

A magneto-optical recording medium of the comparative example was fabricated as a magneto-optical disk of a front illumination system having a multilayer configuration shown in FIG. 11.

In the fabrication of the magneto-optical recording medium of the comparative example, first, a flat glass substrate (diameter 120 mm, thickness 1.2 mm) was applied via a UV-curable resin (trade name: Yupimer, manufactured by Mitsubishi Chemical Co., Ltd.) to the land and groove shape surface of the prescribed Ni stamper, and the UV-curable resin was then cured by UV irradiation (wavelength 255 nm). As a result, a pre-groove pattern with a depth of 50 nm that was identical to those of Embodiments 1, 2 was formed in the resin portion.

The resin portion that has been integrated with the glass substrate is peeled off from the Ni substrate. The magneto-optical recording medium substrate of the comparative example that was composed of the resin portion having a pre-groove surface (shown by a thick line in FIG. 11) and glass substrate was thus fabricated.

In the fabrication of the magneto-optical recording medium of the comparative example, a heat conduction layer (AgPdCuSi, thickness 15 nm), first dielectric layer (SiN, thickness 30 nm), recording layer (TbFeCo, thickness 50 nm), second dielectric layer (SiN, thickness 50 nm), and protective layer (UV-curable transparent resin, thickness 15 μm) were successively formed on the resin portion of the substrate. Methods for forming those layers are identical to those described in Embodiment 1.

The magneto-optical recording medium of the comparative example was thus fabricated.

### COMPARATIVE EXAMPLE 2

A magneto-optical recording medium of another comparative example was fabricated as a magneto-optical disk of a front illumination system having a multilayer configuration shown in FIG. 12.

In the fabrication of the magneto-optical recording medium of the comparative example, first, a magneto-optical recording medium composed of a resin portion having a pre-groove and a glass substrate was fabricated in the same manner as in Comparative Example 1.

Then, a heat conduction layer (AgPdCuSi, thickness 15 nm) and a first dielectric layer (SiN, thickness 30 nm) were formed on the resin portion of the substrate in the same manner as in Embodiment 1.

Then, a soft magnetic layer (thickness 100 nm) of the prescribed composition having a saturated magnetic flux density of 2.0 T was formed on the first dielectric layer by growing a film of CoNiFe by a DC sputtering method. In the sputtering process, a CoNiFe alloy target was used, Ar gas was employed as the sputter gas, the sputter gas pressure was 1.5 Pa, and the discharge power was 800 W. The soft magnetic layer thus obtained had a configuration satisfying the above-described formula (1). Further, the surface roughness (Ra) of the exposed surface of the soft magnetic layer thus formed was 0.6 nm.

In the fabrication of the magneto-optical recording medium of the comparative example, a recording layer (TbFeCo, thickness 50 nm), second dielectric layer (SiN, thickness 50 nm), and protective film (UV-curable transparent resin, thickness 15 μm) were then successively formed on the soft magnetic layer.

Methods for forming those layers are identical to those described in Embodiment 1.

The magneto-optical recording medium of the comparative example was thus fabricated. The pre-groove surface of the substrate is shown by a thick line in FIG. 12.

[Evaluation of Properties]

The dependence of the bit error rate (BER) in reproduced signals on the recording magnetic field was studied for each magneto-optical recording medium of Embodiments 1, 2 and Comparative Examples 1, 2.

More specifically, first, random signals were recorded on the information track in each magneto-optical recording medium (magneto-optical disk). This recording processing was conducted by a magnetic field modulation recording method using the prescribed optical disk evaluation apparatus. The numerical aperture NA in the evaluation apparatus was 0.85 and the laser wavelength was 405 nm. In the recording processing, the laser scanning rate was 7.5 m/s and the prescribed applied magnetic field (recording magnetic field) was modulated while continuously irradiating each information track (land portion, groove portion) with a laser having an optimum power in a range of 6-8 mW.

The magneto-optical recording medium was then reproduced and the error ratio of the reproduced demodulated signal with respect to the recorded modulated signal was calculated as a bit error rate (BER) by comparing the modulated signal during recording and demodulated signal during reproduction. In the reproduction processing, the evaluation apparatus identical to that of the recording processing was used, the laser power was set to 1.5 mW, and the laser scanning speed was set to 7.5 m/s.

Such a recording processing and subsequent reproduction processing were conducted for each recording magnetic field by changing the applied magnetic field (recording magnetic field) in the recording processing, and the BER at each recording magnetic field was measured. The dependence of the BER in each magneto-optical recording medium on the recording magnetic field is shown in the graph in FIG. 13. In the graph shown in FIG. 13, the recording magnetic field (Oe) is plotted against the abscissa and the BER is plotted against the ordinate. The line E1 shows the dependence of the BER on the recording magnetic field in Embodiment 1. Similarly, the line E2, line C1, and line C2 show the dependence of the BER on the recording magnetic field in Embodiment 2, Comparative Example 1, and Comparative Example 2, respectively.

The graph shown in FIG. 13 demonstrates that the BER of the magneto-optical recording medium of Embodiments 1, 2 is lower than that of the magneto-optical recording medium of Comparative Examples 1, 2. Such a difference in the BER characteristic indicates that the recording layer of the magneto-optical recording medium of Embodiments 1, 2 has higher sensitivity with respect to the recording magnetic field (applied magnetic field) than the recording layer of the magneto-optical recording medium of Comparative Examples 1, 2. The recording magnetic field that has to be applied to the magneto-optical recording medium of Embodiment 1 to obtain a BER of 10×10⁻⁴ is about 95 Oe. Similarly, the recording magnetic field that has to be applied to the magneto-optical recording medium of Embodiment 2 and Comparative Example 1 to obtain a BER of 10×10⁻⁴ is about 125 Oe and about 180 Oe, respectively. The higher is the sensitivity of the recording layer to the recording magnetic field, the lower is the recording magnetic field necessary to attain the same BER.

In the magneto-optical recording medium of Comparative Example 2, a soft magnetic layer was formed on the pre-groove layer (resin portion of the substrate). Therefore, the surface roughness (Ra) in the growth upper end of the soft magnetic layer is extremely large (0.6 nm). Such a large surface roughness induces a pinning effect relating to magnetic domains in the recording layer. As a result, magnetization inversion in the recording layer in the course of recording processing is inhibited. It is apparently for this reason, the magneto-optical recording medium of Comparative Example 2 has a higher BER than other magneto-optical recording media at the same recording magnetic field.

1. A magneto-optical recording medium comprising:
a substrate including a pre-groove surface formed with a pre-groove, at least the pre-groove surface being made of a soft magnetic material; and
a material film structure provided on the pre-groove surface of the substrate and including a recording magnetic section executing a recording function and a reproduction function.

2. The magneto-optical recording medium according to claim 1, wherein the substrate is made of a soft magnetic material.

3. The magneto-optical recording medium according to claim 2, wherein the soft magnetic material has a saturation magnetic flux density no lower than 0.5 T.

4. The magneto-optical recording medium according to claim 1, wherein the substrate includes a soft magnetic film constituting the pre-groove surface.

5. The magneto-optical recording medium according to claim 4, wherein the soft magnetic film is made of a soft magnetic material having a saturation magnetic flux density, the saturation magnetic flux density multiplied by a thickness of the soft magnetic film being no lower than 2×10⁻⁷.

6. The magneto-optical recording medium according to claim 1, wherein the pre-groove surface has a surface roughness (Ra) of no greater than 0.3 nm.

7. The magneto-optical recording medium according to claim 1, wherein the recording magnetic section has a multilayer magnetic structure for implementing a MSR-system reproduction, a MAMMOS-system reproduction, or a DWDD-system reproduction.

8. A method for manufacturing a magneto-optical recording medium substrate, the method comprising the steps of:
producing a substrate with a pre-groove surface by growing a soft magnetic material on a pre-groove formation surface of a stamper by an electroforming method, so that a concave-convex shape of the pre-groove formation surface is transferred to the pre-groove surface of the substrate; and
separating the substrate and the stamper.

9. The method for manufacturing a magneto-optical recording medium substrate according to claim 8, wherein the soft magnetic material has a saturation magnetic flux density of no lower than 0.5 T.

10. A method for manufacturing a magneto-optical recording medium substrate, the method comprising the steps of:
forming a resist pattern on a surface of a soft magnetic plate;
forming a pre-groove by conducting an etching processing of the soft magnetic plate with the resist pattern used as a mask; and
removing the resist pattern from the soft magnetic plate.

11. The method for manufacturing a magneto-optical recording medium substrate according to claim 10, wherein the etching processing is conducted by an ion milling method.

12. The method for manufacturing a magneto-optical recording medium substrate according to claim 10, wherein the soft magnetic plate is made of a soft magnetic material having a saturation magnetic flux density of no lower than 0.5 T.

13. The method for manufacturing a magneto-optical recording medium substrate according to claim 10, wherein the soft magnetic plate has a surface roughness (Ra) of no greater than 0.3 nm.

14. A method for manufacturing a magneto-optical recording medium substrate, the method comprising the steps of:
growing a soft magnetic material on a pre-groove formation surface of a stamper for producing a soft magnetic film to which a concave-convex shape of the pre-groove formation surface is transferred;
forming a resin layer on the soft magnetic film for producing a substrate having a laminated structure including the resin layer and the soft magnetic film; and
separating the substrate and the stamper.

15. The method for manufacturing a magneto-optical recording medium substrate according to claim 14, wherein the soft magnetic material of the soft magnetic film has a saturation magnetic flux density, the saturation magnetic flux density multiplied by a thickness of the soft magnetic film being no lower than 2×10⁻⁷ Tm.

16. The method for manufacturing a magneto-optical recording medium substrate according to claim 14, wherein the soft magnetic film is formed by an electroless plating method, and the resin layer is made of polycarbonate or polymethylmethacrylate.
